(19) United States
(12) Patent Application Publication
(10) Pub. No.: US 2011/0019133 A1
(43) Pub. Date: Jan. 27, 2011

(54) LIQUID CRYSTAL DISPLAY DEVICE WITH MIRROR FUNCTION

(76) Inventors: Jeong Hoon Ko, Ulsan (KR); Jin Ho Kim, Gyeonggi-do (KR); Seong Han Hawang, Jeonbuk (KR)

Correspondence Address: MORGAN LEWIS & BOCKIUS LLP, 1111 PENNSYLVANIA AVENUE NW, WASHINGTON, DC, 20004, US

(21) Appl. No.: 12/840,694

(22) Filed: Jul. 21, 2010

(30) Foreign Application Priority Data
Jul. 24, 2009 (KR) 10-2009-0067691

(51) Int. Cl. G02F 1/1335

(52) U.S. Cl. 349/96

(57) ABSTRACT

A LCD device includes a liquid crystal panel, an upper polarizing plate disposed above the liquid crystal panel, a lower polarizing plate disposed under the liquid crystal panel, a retardation film formed on a polarization layer of the upper polarizing plate, and a liquid crystal polarizing film attached to the retardation film. Since the LCD device uses a polarized liquid crystal film that is formed of a liquid crystal films to perform a mirror function, the deterioration in the image quality due to the surface unevenness is improved. Also, since the LCD device uses a polarized liquid crystal film to enable the display function and the mirror function of the LCD device, a user who wears polarized sunglasses can detect the mirror function.

### CROSS-REFERENCE TO RELATED APPLICATION

This application claims priority under 35 U.S.C. 119 to Korean Patent Application No. 10-2009-0067691, filed on Jul. 24, 2009, which is hereby incorporated by reference in its entirety.

### BACKGROUND

1. Field of the Disclosure

This disclosure relates to a liquid crystal display (LCD) device.

2. Description of the Related Art

Recently, liquid crystal display (LCD) devices are used for car navigations, mobile phones, netbooks, or common display devices. In particular, since low earth orbit satellites which are numerously located in the sky above the earth with the development of communications technology are utilized, a user may enjoy various high speed wireless communications services such as moving picture or graphics as well as voice calling with a mobile terminal only under wired/wireless and satellite environments without a limitation in use of any of ground, marine, and air transportations, or in location in and outside a country.

Specifically, personal portable terminals, car navigations, and common display devices to be displayed outdoors are required to basically have a thin and light size that is easy to carry on, to meet the customers' needs, and furthermore, to be equipped with abundant user interfaces and simultaneously to be capable of transmitting and executing high quality audio/video (NV) contents.

To this end, for portable information communications media such as mobile phones, notebooks, laptop computers, and personal digital assistants (PDAs), and mobile terminals such as navigation systems, it is a main design trend to provide a large display screen in such a manner as to minimize the sizes of the media and terminals.

Also, functional display panels having various contents have recently been introduced, for example, a display panel displays an image when a display panel of an LCD device is driven, and functions as a mirror when the display panel of the LCD device is not in use.

FIG. 1 illustrates the structure of a LCD device having a mirror function according to a prior art. Referring to FIG. 1, in the LCD device, an upper polarizing plate 20 and a lower polarizing plate 30 are respectively disposed above and under an LCD panel 10. To implement a mirror function, a mirror film 40 is additionally disposed above the upper polarizing plate 20. The mirror film 40 has a function to reflect or transmit only a selective linear polarization component.

Thus, when the LCD panel 10 is driven in an ON state, the linearly polarized light passing through the lower polarizing plate 30 is converted in the LCD panel 10 to have the same direction as the polarization direction of the upper polarizing plate 20. Then, the linearly polarized light passing through the LCD panel 10 passes through the upper polarizing plate 20 and the mirror film 40 to display an image. A user may see the image implemented by the LCD panel 10.

The upper and lower polarizing plates 20 and 30 are respectively formed of triacetate cellulose (TAC) films 21, 23, 31, and 33 with polarization layers 22 and 32 interposed therebetween.

Also, when the LCD panel 10 is driven in an OFF state, no internal light source of the LCD device exists. Thus, the linear polarization component in a particular direction of an external light source of the LCD device passes through the mirror film 40 to proceed toward the upper polarizing plate 20. Also, a linear polarization component in the other direction is reflected from the surface of the mirror film 40, thereby performing the mirror function.

That is, the LCD panel may be used as an image forming apparatus when the LCD display device is driven, and as a mirror when the LCD display device is not driven. However, the above-described LCD display device according to a prior art has the following problems.

First, since the mirror film 40 attached for the mirror function has severe surface unevenness, the image of the LCD panel 10 is distorted. That is, during the operation of the LCD device, image unevenness or image aberration is generated so that the quality of an image is deteriorated.

Second, during a black operation, a light leakage defect is generated at a particular viewing angle in a black driving mode (when the LCD device displays a black color). Also, a surface scratch defect is frequently generated in the mirror film 40.

Third, when the LCD device is used as a portable terminal, a car navigation, a notebook, a netbook, and an outdoor display, a user often wears polarized sunglasses. However, as described with reference to FIG. 1, according to the principle of the mirror function of the mirror film 40, of external light, a linearly polarized light in a particular direction is transmitted while the other linearly polarization component is reflected. When a user wears polarized sunglasses, the reflected linearly polarized light is blocked by the polarized sunglasses so that the mirror surface of the LCD device may not be seen. That is, the linearly polarized light reflected by the mirror film 40 is completely blocked by the polarized sunglasses before coming into the eyes of the user.

Therefore, the user wearing the polarized sunglasses may not use the mirror function of the LCD device having a mirror function.

### BRIEF SUMMARY

Accordingly, the present embodiments are directed to an LCD device that substantially obviates one or more of problems due to the limitations and disadvantages of the related art.

An object of the present embodiments is to provide an LCD device which is adapted to prevent image distortion of an LCD panel and to perform a mirror function.

Another object of the present embodiment is to provide an LCD device that is adapted to facilitate the mirror function of an LCD panel and to provide the same mirror function to a user wearing polarized sunglasses.

Additional features and advantages of the embodiments will be set forth in the description which follows, and in part will be apparent from the description, or may be learned by practice of the embodiments. The advantages of the embodiments will be realized and attained by the structure particularly pointed out in the written description and claims hereof as well as the appended drawings.

According to one general aspect of the present embodiment, a liquid crystal display device includes a liquid crystal panel, an upper polarizing plate disposed above the liquid crystal panel, a lower polarizing plate disposed under the liquid crystal panel, a retardation film formed on a polarization layer of the upper polarizing plate, and a liquid crystal polarizing film attached to the phase film.

The liquid crystal polarizing film may transmit left linearly polarized light or right linearly polarized light and reflect the opposite right linearly polarized light or left linearly polarized light. The retardation film may have a retardation value of about 100-150 nm.

Other systems, methods, features and advantages will be, or will become, apparent to one with skill in the art upon examination of the following figures and detailed description. It is intended that all such additional systems, methods, features and advantages be included within this description, be within the scope of the invention, and be protected by the following claims. Nothing in this section should be taken as a limitation on those claims. Further aspects and advantages are discussed below in conjunction with the embodiments. It is to be understood that both the foregoing general description and the following detailed description of the present disclosure are exemplary and explanatory and are intended to provide further explanation of the disclosure as claimed.

### BRIEF DESCRIPTION OF THE DRAWINGS

The accompanying drawings, which are included to provide a further understanding of the embodiments and are incorporated in and constitute a part of this application, illustrate embodiment(s) of the invention and together with the description serve to explain the disclosure. In the drawings:

FIG. 1 illustrates the structure of a LCD device having a mirror function according to a prior art;

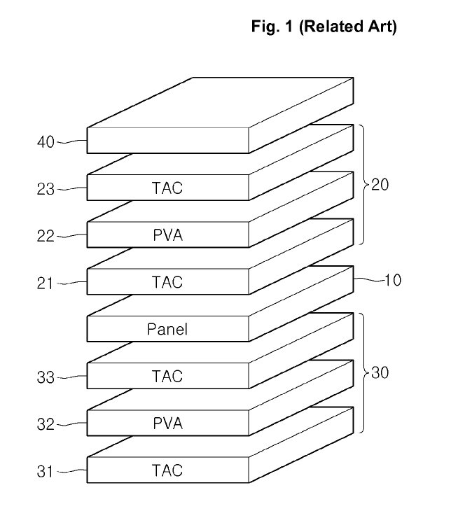

FIG. 2 illustrates the structure of a LCD device having a mirror function according to an embodiment of the present disclosure;

FIG. 3 is a view for explaining the polarization principle of a liquid crystal polarization film and a phase difference film used in the LCD device of FIG. 2;

FIG. 4 illustrates a polarization state when the LCD device of FIG. 2 is driven;

FIG. 5 illustrates a polarization state when the LCD device of FIG. 2 performs a mirror function; and

FIG. 6 is a graph for explaining the principle of implementing a color mirror function according to another embodiment of the present disclosure.

### DETAILED DESCRIPTION

Reference will now be made in detail to the embodiments of the present disclosure, examples of which are illustrated in the accompanying drawings. These embodiments introduced hereinafter are provided as examples in order to convey their spirits to the ordinary skilled person in the art. Therefore, these embodiments might be embodied in a different shape, so are not limited to these embodiments described here. Also, the size and thickness of the device might be expressed to be exaggerated for the sake of convenience in the drawings. Wherever possible, the same reference numbers will be used throughout this disclosure including the drawings to refer to the same or like parts.

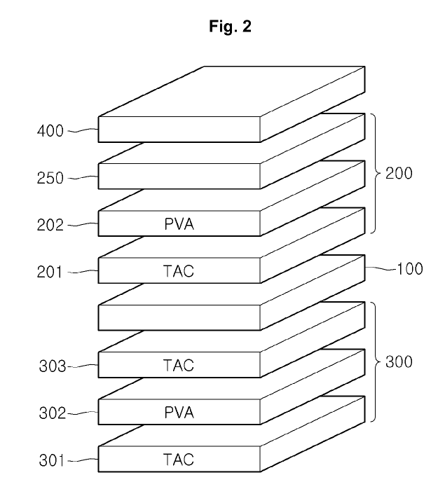

FIG. 2 illustrates the structure of a LCD device having a mirror function according to an embodiment of the present disclosure. Referring to FIG. 2, an upper polarizing plate 200 and a lower polarizing plate 300 are respectively disposed above and under an LCD panel 100 for forming an image. In the LCD panel 100, a plurality of gate lines and a plurality of data lines are arranged to cross each other and a pixel region is located in an area that is defined as the gate lines and the data lines perpendicularly cross each other. A plurality of pixel electrodes and common electrodes to apply an electric field to each pixel region are formed in the LCD panel 100.

Each of the pixel electrodes is connected to the data line via a source terminal and a drain terminal of a thin film transistor (TFT) that is a switching element. The TFT is turned on by a scan pulse applied to the gate terminal via the gate line so that a data signal of the data line may be charge in the pixel electrode.

In the meantime, a driving circuit to drive the LCD panel 100 includes a gate driver for driving the gate lines, a data driver for driving the data lines, a timing controller for supplying a control signal to control the gate driver and the data driver, and a power supply unit for supplying various driving voltages used in the LCD device.

Also, although the LCD device is mainly discussed herein, the present disclosure may be applied to a flat type display such as organic electric field emission display device.

In particular, in the upper polarizing plate 200 of the present disclosure, unlike the upper polarizing plate 20 of the related art, a triacetate cellulose (TAC) film 201 and a retardation film 250 are respectively disposed above and under a polarization layer 202. Also, a liquid crystal polarizing film 400 is formed on the retardation film 250 by using a laminator method. The liquid crystal polarizing film 400 may be formed in a structure in which a plurality of films formed of liquid crystal layers are deposited. Each liquid crystal film is formed of liquid crystal molecules rotated in a direction and polarizes incident light.

Also, the retardation film 250 has a retardation value of λ/4. The retardation film 250 preferably has a retardation value of 100-150 nm.

For example, when light in which left linearly polarized light and right linearly polarized light are mixed is incident, the liquid crystal polarizing film 400 transmits one polarization component and reflects the other polarization component. Also, since a plurality of liquid crystal films are deposited in the liquid crystal polarizing film 400, the quantity of light to be reflected or transmitted may be adjusted by controlling the pitch of the liquid crystal films or the liquid crystal molecular alignment.

The lower polarizing plate 300 is disposed under the LCD panel 100. In the LCD panel 100, TAC films 301 and 303 are disposed opposite each other in the center of a polarization layer 302.

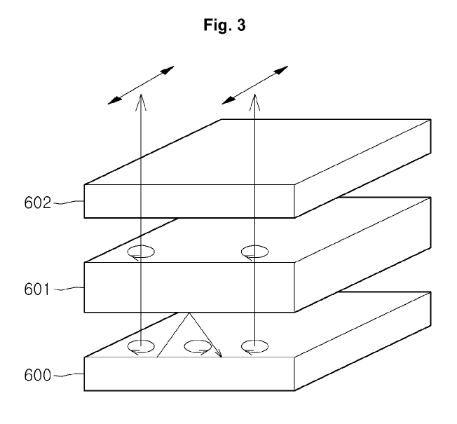

FIG. 3 is a view for explaining the polarization principle of a liquid crystal polarization film and a phase difference film used in the LCD device of FIG. 2. In the drawing, a liquid crystal polarizing film 601 that transmits left linearly polarized light only is mainly discussed.

Referring to FIG. 3, a reflection panel 600 and a retardation film 602 are disposed above and under the liquid crystal polarizing film 601. Of the light reflected from the reflection panel 600, left linearly polarized light passes through the liquid crystal polarizing film 601 and is converted to a linearly polarized light in the retardation film 602. That is, when the liquid crystal alignment direction or the pitch distance of the liquid crystal polarizing film 601 is set to transmit only the left linearly polarized light, only the left linearly polarized light is transmitted while right linearly polarized light is reflected. However, this is not a fixed design structure and, by adjusting the liquid crystal alignment direction or the pitch distance of the liquid crystal polarizing film 601, only the right linearly polarized light or linearly polarized light may be transmitted while the left linearly polarized light may be reflected.

However, of the light reflected from the reflection panel 600, the right linearly polarized light is reflected from the liquid crystal polarizing film 601 and proceeds toward the reflection panel 600. As a result, the right linearly polarized light does no longer proceed through the retardation film 602 and is blocked by the liquid crystal polarizing film 601.

Consequently, the liquid crystal polarizing film 601 transmits a polarization component of a particular direction of the incident light and reflects a polarization component of a different direction, thereby functioning as a mirror. In particular, the liquid crystal polarizing film 601 of the present disclosure can transmit/reflect left linearly polarized light or right linearly polarized light so that a mirror effect may be obtained even when a user wearing polarized sunglasses sees the LCD panel. That is, both of a user who wears polarized sunglasses and a user who does not wear polarized sunglasses may obtain a mirror function effect. However, in the LCD device having a mirror function according to the prior art, since the reflected light is not the left linearly polarized light or the right linearly polarized light, but the linearly polarized light, a user who wears polarized sunglasses may not obtain a mirror function because all the linearly polarization component is blocked off.

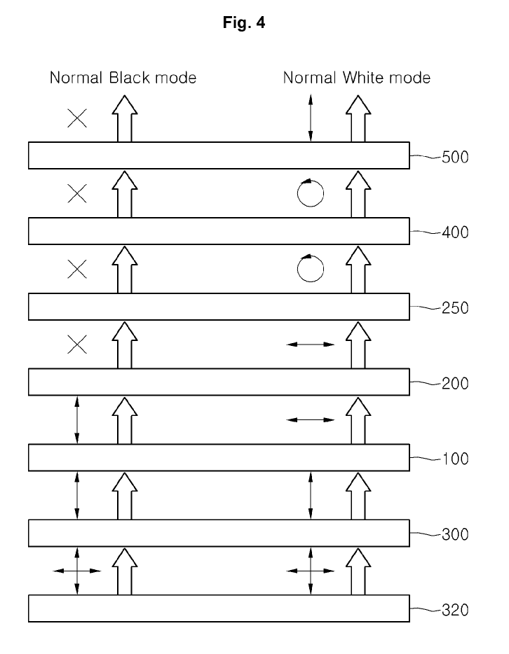

FIG. 4 illustrates a polarization state when the LCD device of FIG. 2 is driven. Referring to FIG. 4, the upper polarizing plate 200 and the lower polarizing plate 300 are respectively disposed above and under the LCD panel 100. A backlight unit 320 is disposed under the lower polarizing plate 300.

Even when the LCD device is in a normally block or normally white mode, the backlight unit 320 emits light. In the normally black mode, the light generated by the backlight unit 320 is light having no polarization direction. While passing through the lower polarizing plate 300, the light turns to linearly polarized light along the polarization axis direction of the lower polarizing plate 300. The linearly polarized light passing through the lower polarizing plate 300 is transmitted without being polarized by the LCD panel 100, and then, is blocked by the polarization axis of the upper polarizing plate 200. Thereafter, since the light transmitting the retardation film 250 and the liquid crystal polarizing film 400 does no longer exist, no light proceeding through polarized sunglasses 500 toward the eyes of an end user exists. Thus, in the normally black mode, the user who wears the polarized sunglasses 500 may normally detect a black state.

In the normally white mode, the light generated by the backlight unit 320 is turned to linearly polarized light by passing through the lower polarizing plate 300, and then, becomes in the LCD panel 100 linearly polarized light in a direction parallel to the polarization axis of the upper polarizing plate 200. Thus, in the normally white mode, the linearly polarized light that transmits the upper polarizing plate 200 exists, and the linearly polarized light is converted to left linearly polarized light by the retardation film 250 and then is transmitted as left linearly polarized light in the liquid crystal polarizing film 400. Here, although the liquid crystal polarizing film 400 is designed to transmit the left linearly polarized light, it may be designed to transmit the right linearly polarized light only in some cases. When the left linearly polarized light is transmitted, the liquid crystal polarizing film 400 reflects the right linearly polarized light. When the right linearly polarized light is transmitted, the liquid crystal polarizing film 400 reflects the left linearly polarized light.

The retardation film 250 has a retardation value of λ/4. The retardation film 250 preferably has a retardation value of 100-150 nm.

The left linearly polarized light transmitting the liquid crystal polarizing film 400 proceeds toward the polarized sunglasses 500 of a user, without a change, and is converted to linearly polarized light. Thus, in the normally white mode, the user who wears the polarized sunglasses 500 may detect a white state.

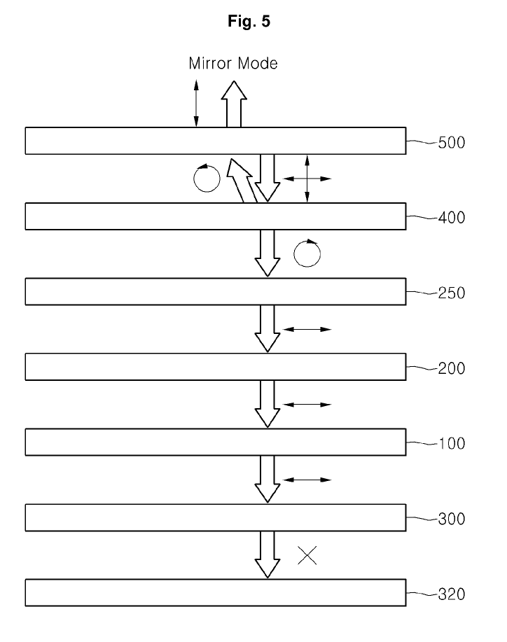

FIG. 5 illustrates a polarization state when the LCD device of FIG. 2 performs a mirror function. Referring to FIG. 5, as the LCD device is not driven when functioning as a mirror, the backlight unit 320 of the LCD device does not generate light.

When an external light (natural light or non-polarized light) proceeds toward the LCD panel 100 via the liquid crystal polarizing film 400 that is the outermost area of the LCD device, first, as described above with reference to FIG. 3, right linearly polarized light is reflected and left linearly polarized light transmits the liquid crystal polarizing film 400 without a change. The left linearly polarized light passing through the liquid crystal polarizing film 400 is converted to linearly polarized light while passing through the retardation film 250. The linearly polarized light output from the retardation film 250 passes through the upper polarizing plate 200 and the LCD panel 100 and proceeds toward the lower polarizing plate 300. Since the polarization axes of the upper polarizing plate 200 and the lower polarizing plate 300 are perpendicular to each other, the light passing through the lower polarizing plate 300 is blocked off. Thus, no light supplied to the area of the backlight unit 320 exist.

The retardation film 250 has a retardation value of λ/4. The retardation film 250 preferably has a retardation value of 100-150 nm.

In the liquid crystal polarizing film 400, however, since the right linearly polarized light is reflected, the reflected right linearly polarized light proceeds toward the polarized sunglasses 500 and then is converted to linearly polarized light to be detected by the eyes of the user. Thus, when the LCD device performs a mirror function, both of a user who wears the polarized sunglasses 500 and a user who does not wear the polarized sunglasses 500 may detect the mirror function.

However, since in the mirror film used in the prior art the reflected light is the linearly polarized light having a particular direction, a user wearing polarized sunglasses may not detect a mirror function. That is, only a user who does not wear the polarized sunglasses may detect the mirror function.

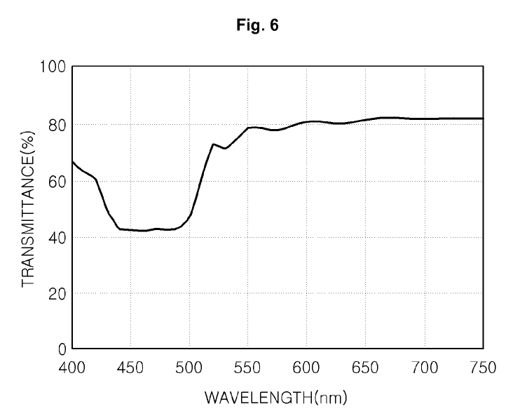

FIG. 6 is a graph for explaining the principle of implementing a color mirror function according to another embodiment of the present disclosure. Referring to FIG. 6, the quantity of transmitted light and the quantity of reflected light may be adjusted by controlling the design conditions of the liquid crystal polarizing film of the present disclosure.

In particular, by increasing the quantity of reflected light in a particular wavelength range, the reflection light may present colors of red (R), green (G), and blue (B). For example, as shown in the graph of FIG. 6, by decreasing the transmittance of light corresponding to a range of 400 nm and increasing the reflectance of the light, the reflected light of a corresponding wavelength range increases so that the liquid crystal polarizing film performing a mirror function presents blue light.

As such, the design of the liquid crystal polarizing film is available by changing the thickness of the liquid crystal polarizing film by adjusting the number of the deposited liquid crystal films, or by adjusting the liquid crystal molecular alignment of the liquid crystal polarizing film.

Thus, according to the present disclosure, while a LCD device having a mirror function is implemented, the surface of a mirror has a particular color so that a mirror mode having various contents may be provided to a user.

In the present disclosure, by using liquid crystal polarizing film in which a plurality of liquid crystal layer films are deposited to enable the mirror function, the uniformity of a surface is improved so that the quality of an image to be displayed may be prevented from being deteriorated.

Also, in the present disclosure, the liquid crystal polarizing film having a mirror function transmits and reflects not only the linearly polarized light only, but also both the left linearly polarized light and the right linearly polarized light, so that a user who wears polarized sunglasses may obtain a mirror function effect.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A liquid crystal display device with a mirror function comprising:
a liquid crystal panel;
an upper polarizing plate disposed above the liquid crystal panel;
a lower polarizing plate disposed under the liquid crystal panel;
a retardation film formed on a polarization layer of the upper polarizing plate; and
a liquid crystal polarizing film attached to the retardation film.

2. The liquid crystal display device claimed as claim 1, wherein the liquid crystal polarizing film transmits left linearly polarized light or right linearly polarized light and reflects the opposite right linearly polarized light or left linearly polarized light.

3. The liquid crystal display device claimed as claim 1, wherein the retardation film has a retardation value of about 100-150 nm.

4. The liquid crystal display device claimed as claim 1, wherein the liquid crystal polarizing film has a structure in which a plurality of liquid crystal films are deposited.

5. The liquid crystal display device claimed as claim 4, wherein the liquid crystal polarizing film adjusts light transmittance by adjusting any one of the liquid crystal molecular alignment and the thickness of the plurality of stacked liquid crystal films.

6. The liquid crystal display device claimed as claim 1, wherein, when the liquid crystal display device is in a mirror function mode, the liquid crystal polarizing film reflects only left linearly polarized light or right linearly polarized light.

7. The liquid crystal display device claimed as claim 1, wherein, when the liquid crystal display device is in a mirror function mode, the liquid crystal polarizing film adjusts light transmittance for each wavelength range to make the wavelength of reflected light any one of red, green, and blue color lights.
